(19) United States
(12) Patent Application Publication
(10) Pub. No.: US 2004/0196798 A1
(43) Pub. Date: Oct. 7, 2004

(54) System and method for wireless transmission of signals using multiple channels assigned in response to signal type

(76) Inventor: Glen P. Abousleman, Scottsdale, AZ (US)

Correspondence Address: Lowell W. Gresham, Meschkow & Gresham, PLC, Suite 409, 5727 North 7th Street, Phoenix, AZ, 85014, US

(21) Appl. No.: 10/404,791

(22) Filed: Apr. 1, 2003

(51) Int. Cl. H04B 7/185; H04H 1/00

(52) U.S. Cl. 370/316; 455/3.02

(57) ABSTRACT

A method of utilizing low-data-rate wireless channels (46) in a satellite-based wireless communication network (20) detects a transmit signal (64) and determines a data type (120, 122, 124) for the transmit signal (64). A quantity of the wireless channels (46) are assigned for transmission of the transmit signal (64) in response to the data type (120, 122, 124). An inverse multiplexing system (50) selectively splits the transmit signal (64) into multiple subsectional signals for transmission over separate wireless channels (46) to facilitate the transmission of large data files and real-time video imagery over the low-data-rate wireless channels (46).

### TECHNICAL FIELD OF THE INVENTION

The present invention relates to the field of wireless communication systems. More specifically, the present invention relates to a system and method for the transmission of signals using multiple channels over a satellite-based communication network.

### BACKGROUND OF THE INVENTION

Technological advances in recent years have made it easier for individuals and groups in geographically disperse societies to be interconnected through physical travel and communication systems. Major advances in the telecommunications infrastructure have been developed and are continuously evolving to meet the needs of people who regularly travel, communicate, and do business internationally. For example, satellite-based global communication networks have arisen to serve the needs of global travelers and communicators. One such network, first activated in 1998, is the Iridium® commercial system. The Iridium® commercial system is a satellite-based global digital communication network designed to provide wireless communications through hand-held devices located anywhere near or on the surface of the Earth.

FIG. 1 illustrates a highly simplified diagram of a satellite-based communication network 20, dispersed over and surrounding Earth through the use of orbiting satellites 22 occupying orbits 24. Network 20 uses six polar orbits 24, with each orbit 24 having eleven satellites 22 for a total of sixty-six satellites 22. As such, network 20 exemplifies the Iridium® commercial system.

Satellites 22 communicate with radio communication individual subscriber units (ISU's) 26 over subscriber links 28. In addition, satellites 22 communicate with earth terminal/gateway systems 30, which provide access to a public switched telephone network (PSTN) 32 or other communications facilities, over earth links 34. Earth terminal/gateway systems 30 (referred to hereinafter as gateways 30) relay data packets (e.g., relating to calls in progress) between ISU's 26 and the PSTN 32 to other communication devices, such as a wireline telephone 36. Satellites 22 also communicate with other nearby satellites 22 through cross-links 40. For simplicity of illustration, only one each of ISU's 26, gateways 30, and a wireline telephone 36 are shown in FIG. 1.

With the exemplary constellation of sixty-six satellites 22, at least one of satellites 22 is within view of each point on the Earth's surface at all times, resulting in full coverage of the Earth's surface. Any satellite 22 may be in direct or indirect data communication with any ISU 26 or gateway 30 at any time by routing data through the constellation of satellites 22. Accordingly, communication network 20 may establish a communication path for relaying information through the constellation of satellites 22 between any two ISU's 26, or between ISU 26 and gateway 30.

Network 20 may accommodate any number, potentially in the millions, of ISU's 26. Subscriber links 28 encompass a limited portion of the electromagnetic spectrum that is divided into numerous channels, and are preferably combinations of L-Band frequency channels. Subscriber links 28 may encompass one or more broadcast channels 42, that ISU's 26 use for synchronization and message monitoring), and one or more acquisition channels 44 that ISU's 26 use to transmit messages to satellites 22. Broadcast channels 42 and acquisition channels 44 are not dedicated to any one ISU 26 but are shared by all ISU's 26 currently within view of a satellite 22.

Subscriber links 28 also include wireless traffic channels 46, also known as voice channels. Traffic channels 46 are two-way channels that are assigned to particular ISU's 26 from time to time for supporting real-time communications. Each traffic channel 46 has sufficient bandwidth to support a two-way voice communication. For example, each of traffic channels 46 within the Iridium® network are capable of approximately 2.4 kilobits/second (kbps) raw data throughput.

Increasingly, individuals wish to utilize such satellite-based networks to transmit large data files and real-time video, in addition to voice communications. Unfortunately, transmission of imagery, video, and data over low-bit-rate, wireless links, such as traffic channels 46 is extremely problematic due to limited channel bandwidth and inherent channel errors. In particular, for wireless links with very low bandwidths, such as the 2.4 kbps traffic channels 46 of network 20, real-time transmission of video has been considered infeasible.

Consequently, what is needed is a technique for extending the capability of voice-optimized traffic channels, within a wireless communication system, for the transmission of data and video.

### SUMMARY OF THE INVENTION

Accordingly, it is an advantage of the present invention that a system and method are provided for utilizing wireless channels in a satellite-based communication network.

It is another advantage of the present invention that a system and method are provided that selectively combine multiple wireless channels for the transmission of data and video.

Another advantage of the present invention is that implementation of the system and method are transparent to the existing infrastructure of the satellite-based communication network.

The above and other advantages of the present invention are carried out in one form by a method for utilizing wireless channels in a wireless communication system, the wireless communication system including a first communication station and a second communication station. The method calls for detecting a transmit signal at the first communication station, determining a data type of the transmit signal, and assigning a quantity of the wireless channels for transmission of the transmit signal in response to the data type. The method further calls for enabling transmission of the transmit signal toward the second communication station over the quantity of the wireless channels.

The above and other advantages of the present invention are carried out in another form by an apparatus for selectively utilizing wireless channels in a wireless communication system. The apparatus includes a data input/output (I/O) port for receiving a data signal, an inverse multiplexer in communication with the data I/O port, and a voice port for receiving a voice signal. The apparatus further includes transceivers in selective communication with each of the voice port and an output of the inverse multiplexer, one each of the transceivers supporting one each of the wireless channels. A processor in communication with the inverse multiplexer, the voice port, and the transceivers enables transmission of the data signal and the voice signal via the transceivers over the wireless channels. When the data signal is received, the processor performs operations including determining a data type for the data signal, ascertaining an available number of the wireless channels, and allocating the available number of the channels to be a quantity of the wireless channels for transmission of the data signal, the quantity of the wireless channels being greater than one. When the voice signal is received, the processor assigns one of the wireless channels for transmission of the voice signal.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a highly simplified diagram of a satellite-based communication system;

FIG. 2 shows a simplified diagram of a portion of the satellite-based communication system in which an inverse multiplexer (IMUX) system in accordance with a preferred embodiment of the present invention is employed;

FIG. 3 shows a block diagram of the IMUX system of FIG. 2;

FIG. 4 shows a simplified diagram of a portion of the satellite-based communication system in which a public switched telephone network (PSTN) IMUX system in accordance with an alternative embodiment of the present invention is employed;

FIG. 5 shows a block diagram of the PSTN-IMUX system of FIG. 4;

FIG. 6 shows a simplified diagram of a portion of the satellite-based communication system in which a gateway-IMUX system in accordance with an alternative embodiment of the present invention is employed;

FIG. 7 shows a flow chart of a channel assignment process of the present invention;

FIG. 8 shows a flow chart of a data signal management subprocess of the channel assignment process of FIG. 7;

FIG. 9 shows a flow chart of a voice signal management subprocess of the channel assignment process of FIG. 7;

FIG. 10 shows a flow chart of a video signal management subprocess of the channel assignment process of FIG. 7; and

FIG. 11 shows a flow chart of a transmit signal receipt process of the present invention.

### DETAILED DESCRIPTION OF THE PREFERRED EMBODIMENTS

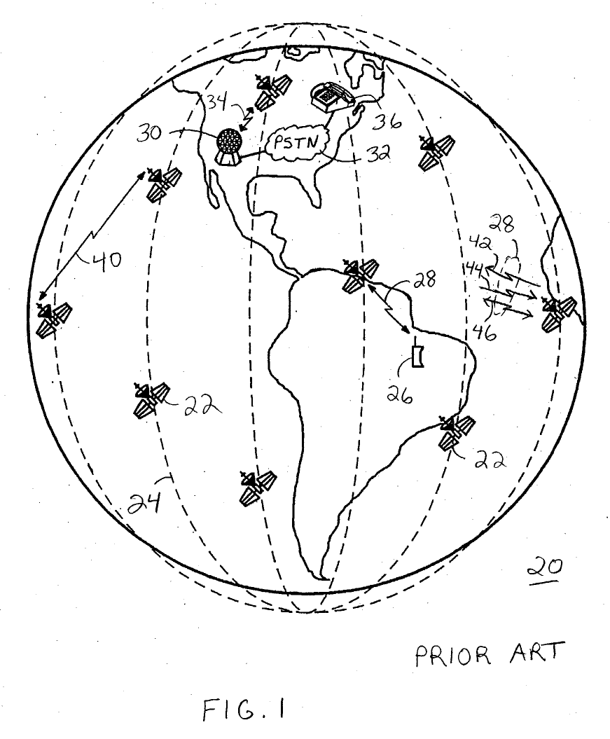

Referring to FIG. 1, the present invention is adapted for use with a satellite-based communication network, such as network 20, exemplifying the Iridium® commercial system. The present invention extends the capability of voice-optimized wireless traffic channels 46, within network 20, for the transmission of data and video, without the addition of terrestrial or airborne network infrastructure.

Although the present invention is described in terms of its use with the Iridium® commercial system, the present invention is not limited to such a use. Rather, the present invention is applicable to land-based communication systems, as well as to other existing or upcoming satellite-based communication networks. The existing or upcoming satellite-based communication networks may have low-earth or medium-earth orbits, may entail orbits having any angle of inclination (e.g., polar, equatorial or another orbital pattern), and may utilize more or fewer orbits. The present invention is also applicable to satellite constellations where full coverage of the Earth is not achieved (i.e., where there are “holes” in the communications coverage provided by the constellation) and constellations where plural coverage of portions of the Earth occur (i.e., more than one satellite is in view of a point on the Earth's surface). In addition, all gateways 30 and ISUs 26 of network 20 are or may be in data communication with other telephonic devices dispersed throughout the world through PSTN 32 and/or conventional terrestrial cellular telephone devices coupled to the PSTN through conventional terrestrial base stations.

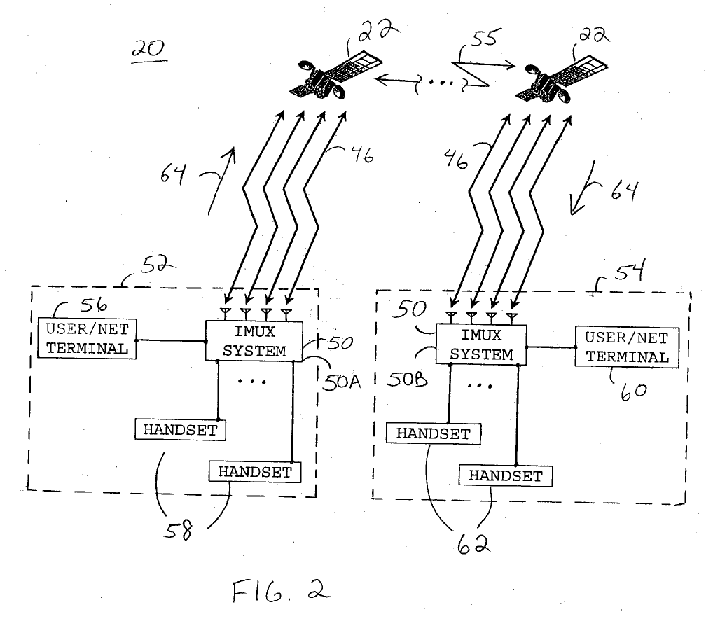

FIG. 2 shows a simplified diagram of a portion of satellite-based communication network 20 in which inverse multiplexer (IMUX) systems 50 are employed in accordance with a preferred embodiment of the present invention. Network 20 includes a first communication station 52 and a second communication station 54. First and second communication stations 52 and 54 may be located on or near the surface of the earth, in isolated or populous areas, and remote from or nearby one another.

FIG. 2 depicts that first and second communication stations 52 and 54, respectively, are deployed in a “mobile-to-mobile” configuration. In the “mobile-to-mobile” configuration, first and second communication stations 52 and 54 are enabled to communicate with one another. But nothing requires stations 52 and 54 to move. In one embodiment, the mobile-to-mobile link is routed through a gateway 30 (FIG. 1), which yields an approximate usable data rate of 2.4 kbps for the exemplary Iridium®-based network. In another embodiment, the mobile units communicate with one another, completely bypassing one of gateways 30 (FIG. 1). As a consequence of the mobile-to-mobile configuration, limited gateway modems are freed up for other users, and maximum data throughput is increased from the data rate of 2.4 kbps over each of traffic channels 46 (FIG. 1) to approximately 3.4 kbps for the exemplary Iridium®-based network. A discontinuous bi-directional arrow 55 is depicted between satellites 22. This discontinuous arrow 55 indicates that a number of cross-links 40 (FIG. 1) and satellites 22 may be employed to form the communication path between first communication station 52 and second communication station 54, as known to those skilled in the art. Alternatively, and as known to those skilled in the art, the communication path need not include two or more satellites 22. Rather, the communication path may include only one of satellites 22 with switching taking place at the satellite to another antenna beam.

First communication station 52 includes a first one of IMUX systems 50, referred to hereinafter as first IMUX system 50A. First communication station 52 also includes a first user/net terminal 56 and handsets 58 in communication with first IMUX system 50A. Similarly, second communication station 54 includes a second one of IMUX systems 50, referred to hereinafter as second IMUX system 50B. A second user/net terminal 60 and handsets 62 are in communication with second IMUX system 50B. User/net terminals 56 and 60 represent any of a wide variety of equipment, including any form of computer, telecommunication, and/or input/output device, which may provide or receive data in any of a wide variety of formats. Such equipment include interface devices for coupling stations 52 and/or 54 to a local or wide area network, the Internet, phone lines, and the like. For simplicity of illustration, the present invention is described in terms of a transmit signal, represented by arrows 64, originating at first IMUX system 50A for transmission toward second IMUX system 50B. However, it should be understood that each of IMUX systems 50 within network 20 functions similarly. For voice transmission, connections need not be between first IMUX system 50A and second IMUX system 50B, but can be between either IMUX system 50A or 50B and any telephone throughout the globe, as facilitated by network 20.

IMUX systems 50 maintain the capability of two-way voice communication provided by network 20, and concurrently facilitate the transmission of large data files and real-time video imagery using network 20. A transmitting one of IMUX systems 50, i.e., first IMUX system 50A, facilitates the transmission of large data files and real-time video imagery by splitting an input data or video signal (discussed below) received via first user/net terminal 56, and transmitting different portions of the data or video signal as transmit signal 64 over separate traffic channels 46. A receiving one of IMUX systems 50, i.e., second IMUX system 50B, combines the different portions of transmit signal 64 to recover the original data or video signal. The net result of such a system is that the effective bandwidth multiplication is directly proportional to the number of traffic channels 46 used.

Communication between communication stations 52 and 54 may be initiated by either side. Once communication has been initiated, either side can either receive or transmit at any time. In the preferred embodiment, communication stations 52 may incorporate a conventional IP stack, allowing any conventional activity performed at a computer, such as access the Internet, FTP files, and the like, may be performed over the communication link established by communication stations 52 and 54.

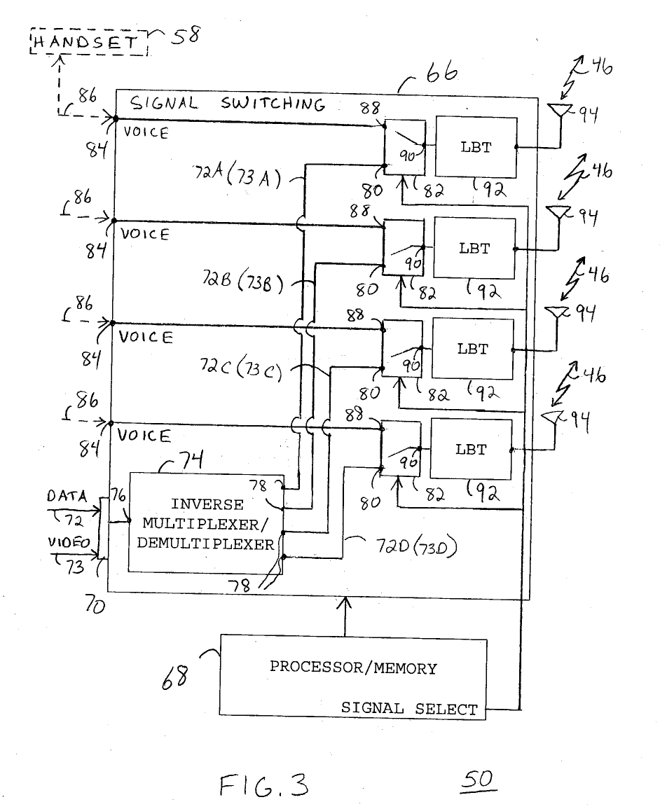

FIG. 3 shows a block diagram of one of IMUX systems 50, i.e., first IMUX system 50A. First IMUX system 50A generally includes a signal switching element 66 and a processor/memory element 68 in communication with signal switching element 66.

Signal switching element 66 includes a data input/output (I/O) port 70 for receiving a data signal 72 and/or a video signal 73 for transmission over network 20 (FIG. 1). Data signal 72 may be a large data file previously generated by and/or collected at first user/net terminal 56. Video signal 73 may be imagery generated at first user/net terminal 56 (FIG. 2) using a multimedia software application, such as that used for videoconferencing. Data I/O port 70 may include one or more receptacles to accommodate, for example, an Ethernet connection, a serial connection, a Universal Serial Bus (USB) connection, and so forth.

An inverse multiplexer/demultiplexer 74 is in communication with data I/O port 70 via an IMUX input 76. IMUX 74 further includes IMUX outputs 78, a number of which corresponds to a number of wireless traffic channels 46 over which first IMUX system 50A is configured to communicate. IMUX 74 may be implemented as an application specific integrated circuit, or may be implemented in a digital signal processor, and is preferably a commercially available device.

In an exemplary embodiment, first IMUX system 50A is a four channel IMUX system 50. Accordingly, inverse multiplexer/demultiplexer 74 includes four IMUX outputs 78, each of which are in communication with first inputs 80 of four corresponding switches 82. Although IMUX system 50A is a four channel IMUX system 50, it should be understood that a different number of channels may be employed within one of IMUX systems 50. In addition, a pair of four channel IMUX systems may be arranged in a master/slave configuration to achieve an eight channel IMUX system. Additionally, N IMUX units 50 may be connected to one another to provide a 4N channel IMUX system.

Signal switching element 66 further includes one or more voice ports 84 for receiving a voice signal 86. In the exemplary four channel embodiment, IMUX system 50 may include four voice ports 84 for accommodating up to four individual voice signals 86 from handsets 58. Hence, the four voice ports 84 are in communication with second inputs 88 of the four corresponding switches 82. Switch outputs 90 of each of switches 82 are in communication with L-band transceivers 92, which are in turn, in communication with external antennas 94.

Processor/memory element 68 controls L-band transceivers 92 and coordinates the flow of data signal 72, video signal 73, and voice signals 86 to and from first IMUX system 50A. As such, processor/memory element 68 is responsive to the detection of data signal 72, video signal 73, and voice signals 86 for adjusting switches 82 to control the flow of communication over wireless traffic channels 46.

Inverse multiplexing is a process of dividing a high-bandwidth data stream into multiple subsectional signals that can be routed independently through a carrier's network. IMUX 74 functions to split data signal 72 and/or video signal 73 into a number of subsectional signals 72A(73A), 72B (73B), 72C (73C), and 72D (73D) and to process and present subsectional signals 72A(73A), 72B (73B), 72C (73C), and 72D (73D) to first inputs 80 of switches 82. IMUX 74 may also perform error detection and synchronization procedures as required, utilizing methodology known to those skilled in the art.

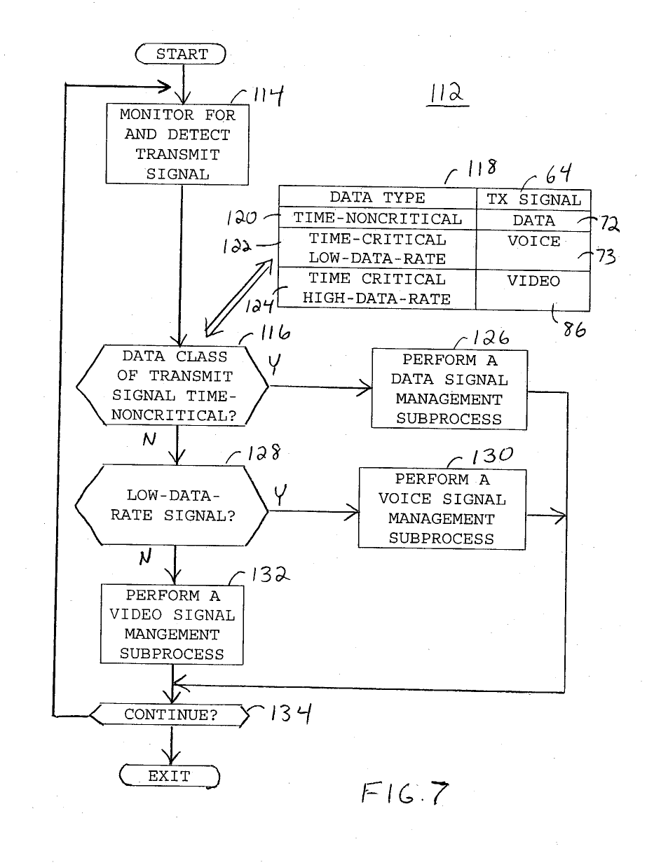

The number of subsectional signals 72A(73A), 72B(73B), 72C (73C), and 72D (73D) is determined by processor/memory element 68 in response to a number of wireless traffic channels 46 that may be available for transmission of subsectional signals 72A(73A), 72B(73B), 72C (73C), and 72D (73D), discussed in connection with the flow charts of FIGS. 7-11. Subsectional signals 72A(73A), 72B(73B), 72C (73C), and 72D (73D) are subsequently realigned at the far end, i.e., by another of IMUXs 74 at another of IMUX systems 50, into the original high-bandwidth data signal 72 and/or video signal 73.

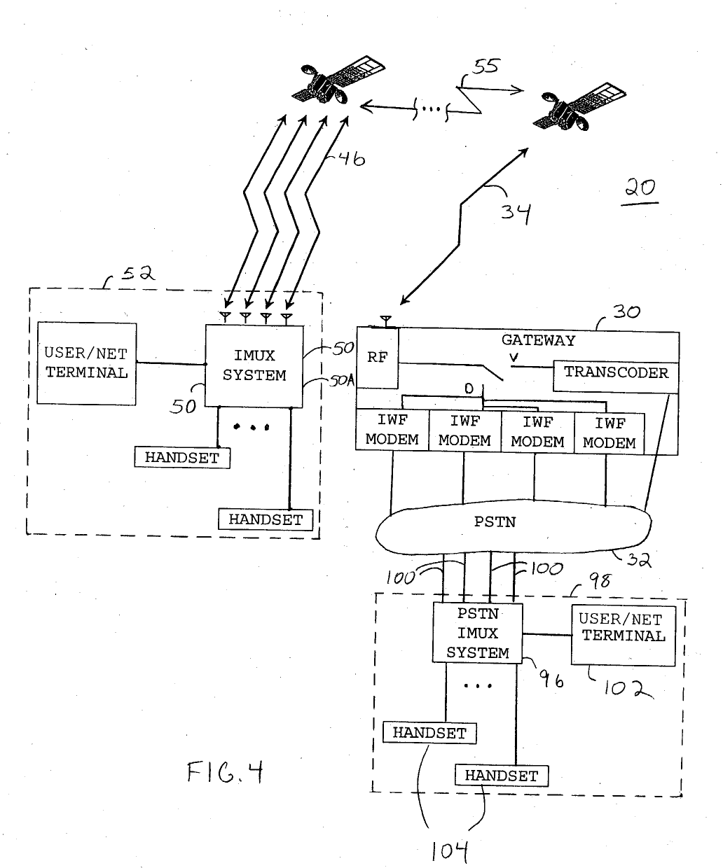

FIG. 4 shows a simplified diagram of a portion of satellite-based communication network 20 in which a public switched telephone network (PSTN) IMUX system 96 is employed in accordance with an alternative embodiment of the present invention. As an adjunct to the “mobile-to-mobile” configuration of FIGS. 2-3, first communication station 52 and a third communication station 98, are deployed in a “mobile-to-PSTN” configuration. In the “mobile-to-PSTN” configuration, first and third communication stations 52 and 98, respectively, are enabled to communicate with one another via satellite-based communication network 20 and PSTN 32 infrastructure.

More specifically, first communication station 52 communicates via traffic channels 46 to one of satellites 22. The communication pathway may proceed via a number of cross-links 40 (FIG. 1) and satellites 22, as represented by discontinuous bi-directional arrow 55, to earth link 34. Earth link 34 directs communication to gateway 30. Conventional switching occurs at gateway 30, to connected PSTN phone lines 100 using standard Iridium® commercial network service. Like first IMUX system 50A, a third user/net terminal 102 and handsets 104 may be in communication with PSTN-IMUX system 96.

PSTN-IMUX system 96 facilitates Iridium® connectivity via PSTN phone lines 100. That is, like IMUX systems 50, PSTN-IMUX system 96 maintains the capability of two-way voice communication provided by network 20 with subscriber units 26 (FIG. 1), while concurrently, facilitating the transmission of large data files and real-time video imagery to other IMUX systems 50 using network 20.

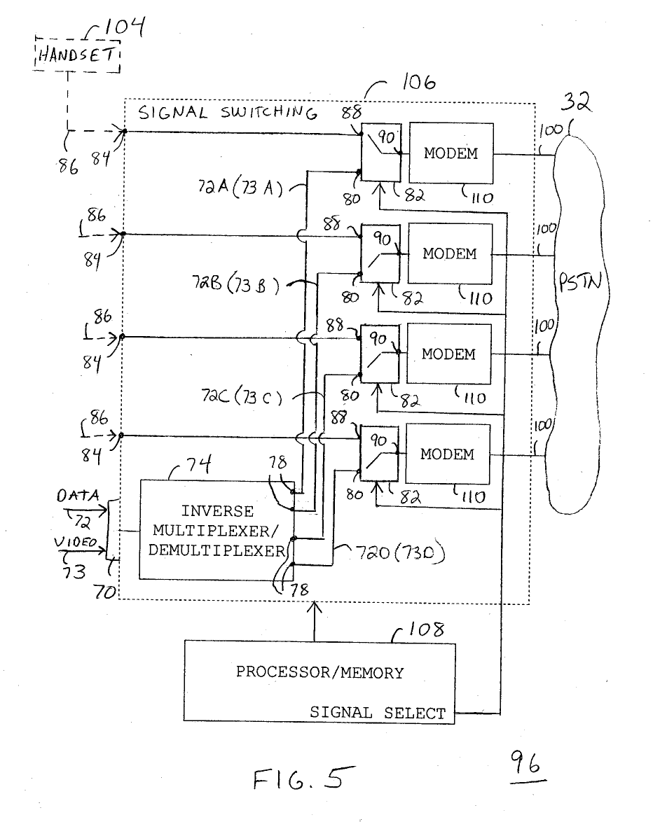

FIG. 5 shows a block diagram of PSTN-IMUX system 96. PSTN-IMUX system 96 generally includes a signal switching element 106 and a processor/memory element 108 in communication with signal switching element 106. PSTN-IMUX system 96 is configured similarly to IMUX systems 50 (FIGS. 2-3). That is, PSTN-IMUX system includes data I/O port 70 for receiving data signal 72 and/or video signal 73, and IMUX 74 in communication with data I/O port 70. IMUX outputs 78 of IMUX 74 are in communication with first inputs 80 of four corresponding switches 82. Voice ports 84 of signal switching element 106 are in communication with second inputs 88 of the four corresponding switches 82.

Unlike IMUX systems 50, PSTN-IMUX system 96 does not include L-band transceivers 92 (FIG. 3) and external antennas 94 (FIG. 3) in communication with switch outputs 90 of each of switches 82. Rather, switch outputs 90 of PSTN-IMUX system 96 are in communication with corresponding modems 110, which are in turn, in communication with PSTN phone lines 100.

Processor/memory element 108 controls modems 110 and coordinates the flow of data signal 72, video signal 73, and voice signals 86 to and from PSTN-IMUX system 96. As such, processor/memory element 108 is responsive to the detection of data signal 72, video signal 73, and voice signals 86 for adjusting switches 82 to control the flow of communication over PSTN phone lines 100. In this PSTN-IMUX system 96 configuration, IMUX 74 also functions to split data signal 72 and/or video signal 73 into a number of subsectional signals 72A(73A), 72B(73B), 72C(73C), and 72D(73D). The number of subsectional signals 72A(73A), 72B(73B), and 72C(73C), and 72D(73D) is determined by processor/memory element 108 in response to a number of wireless traffic channels 46 that may be available for transmission of subsectional signals 72A(73A), 72B(73B), 72C(73C), and 72D(73D), discussed in connection with the flow charts of FIGS. 7-11. Subsectional signals 72A(73A), 72B(73B), 72C(73C), and 72D(73D) are subsequently realigned at the far end, i.e., by another of IMUX systems 50 or PSTN-IMUX systems 96, into the original data signal 72 and/or video signal 73.

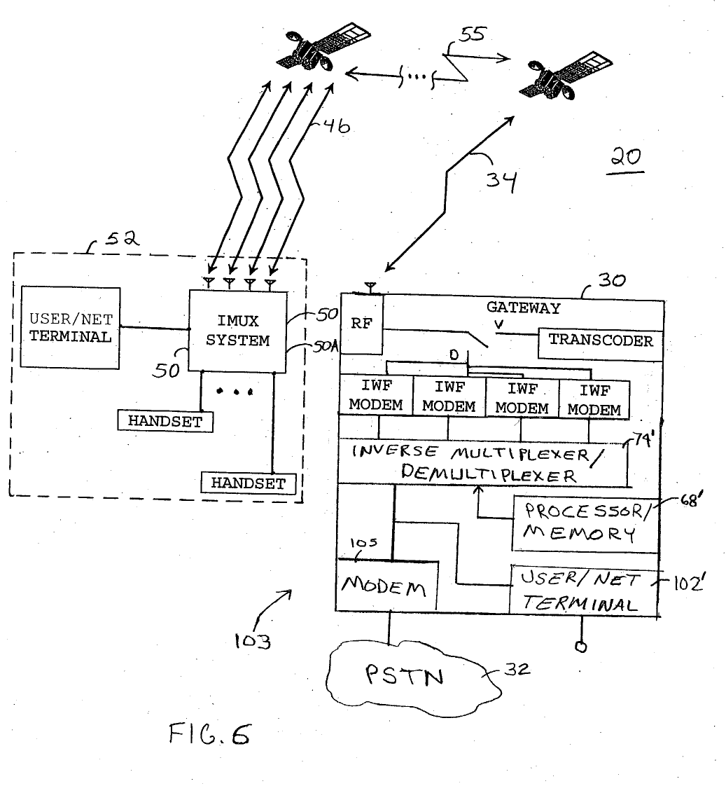

FIG. 6 shows a block diagram of yet another IMUX system, but configured in the form of a gateway-IMUX system 103. Gateway-IMUX system 103 is configured similarly to PSTN-IMUX system 96 (FIG. 5), but the IMUX functionality discussed in connection with one of the communication stations mentioned above is now included in gateway 30. Generally, gateway 30 includes an inverse multiplexer/demultiplexer (IMUX) 74′ that couples to a predetermined number of gateway modems. A processor/memory element 68′ couples to and controls IMUX 74′ in much the same way as discussed above. Likewise, a user/net terminal 102′ couples to IMUX 74′ at a port 70′ in much the same manner as discussed above. But a modem 105 may also be included and couple between IMUX 74′ for use in interfacing to the PSTN 32. Through modem 105 or user/net terminal 102′, a stream of data configured in any of a wide variety of formats may be routed through gateway-IMUX 103.

The following flow charts of FIGS. 7-11 describe the activities performed by IMUX systems 50, PSTN-IMUX systems 96, and/or gateway-IMUX systems 103 for intelligently combining a quantity of low-data-rate traffic channels 46 to form an effective higher-rate channel to accommodate the transmission of large data files and real-time video imagery, while maintaining the two-way voice communication provided by network 20. The processes of FIGS. 7-11 are carried out by code stored at and executed by processor/memory element 68 of IMUX systems 50, by processor/memory element 108 of PSTN-IMUX systems 96 and/or processor/memory element 68′ of gateway-IMUX systems 103. As mentioned above, for simplicity of illustration the following processes will be described with first IMUX system 50A (FIG. 2) initiating transmission of transmit signal 64 (FIG. 2) for receipt at second IMUX system 50B (FIG. 2), i.e. the “mobile-to-mobile” configuration.

FIG. 7 shows a flow chart of a channel assignment process 112 of the present invention. Channel assignment process 112 generally monitors for transmit signals intended for transmission from first communication station 52 (FIG. 2), and determines a data type for each of the detected transmit signals. Transmit signal 64 may be data signal 72, video signal 73, or voice signal 86. In an exemplary embodiment, the data type of a signal describes its time criticality and projected data rate. In response to its time criticality and projected data rate, processor/memory element 68 subsequently assigns a quantity of wireless traffic channels 46 for transmission of transmit signal 64.

Channel assignment process 112 begins with a task 114. Task 114 monitors for transmit signal 64 (FIG. 2) intended for transmission from first communication station 52. In other words, first IMUX system 50A monitors for wireless channel acquisition signaling pertaining to the presence of data signal 72, video signal 73, or voice signal 86. Wireless channel acquisition signaling may be, for example, a conventional set-up message for originating wireless communication. When transmit signal 64 is detected in the form of one of data, video, or voice signals 72, 73, and 86, respectively, process 112 proceeds to a query task 116.

At query task 116, processor/memory element 68 evaluates transmit signal 64 to determine its data type. Processor/memory element 68 may be configured to identify a variety of data types. The data type of each transmit signal 64 affects a quantity of wireless traffic channels 46 assigned for transmission of transmit signal 64, as well as a transmission mode, discussed below. In an exemplary embodiment, processor/memory element 68 determines the data type of transmit signal 64 in response to time-criticality and projected data rate parameters of transmit signal 64.

A table 118 associated with query task 116 defines three prospective data types for transmit signal 64. For example, a “time-noncritical” data class 120 indicates there is no significant real-time transmission requirement imposed upon the transmission of transmit signal 64. Thus, transmit signal 64 is data signal 72. Conversely, a “time-critical, low data rate” data class 122 indicates that there is a real-time transmission requirement imposed upon the transmission of transmit signal 64, and a single one of traffic channels is sufficient for transmission of transmit signal. In such a scenario, transmit signal 64 is voice signal 86. Alternatively, a “time-critical, high data rate” data class 124 indicates that there is a real-time transmission requirement imposed upon the transmission of transmit signal 64, and a single one of traffic channels is insufficient for transmission of transmit signal. In such a scenario, transmit signal 64 is video signal 73.

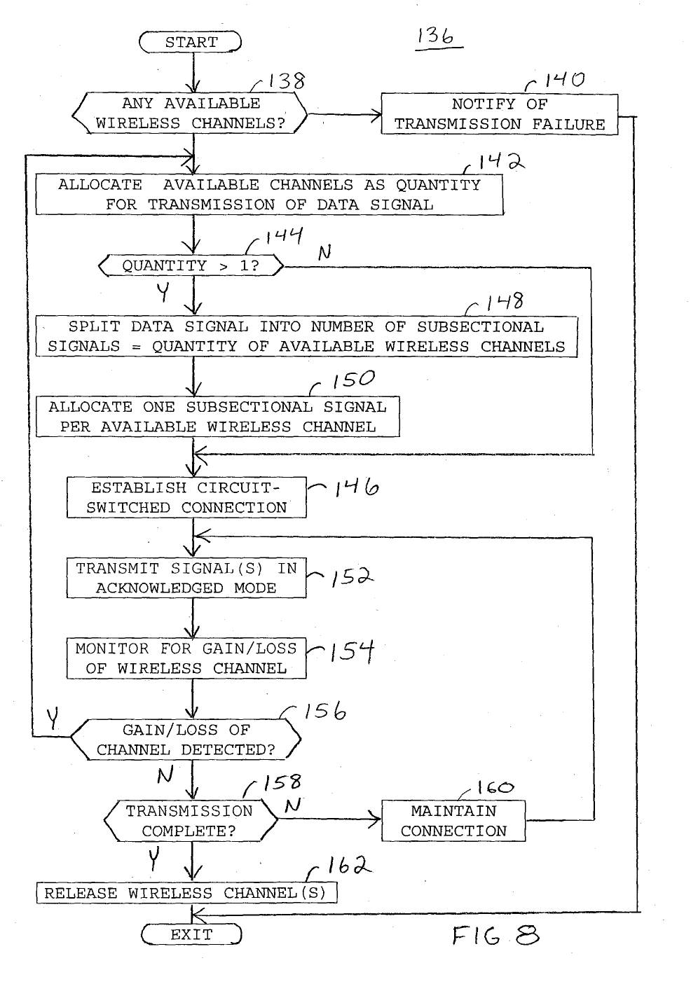

When query task 116 determines that transmit signal 64 exhibits time-noncritical data class 120, process 112 proceeds to a task 126. At task 126, a data signal management subprocess is performed. The data signal management subprocess is described below in connection with FIG. 8.

When query task 116 determines that transmit signal 64 does not exhibit time-noncritical data class 120, process 112 proceeds to a query task 128. At query task 128, processor/memory element 68 determines whether transmit signal 64 is a low-data-rate signal, i.e. whether transmit signal 64 is time-critical, low-data-rate data class 122.

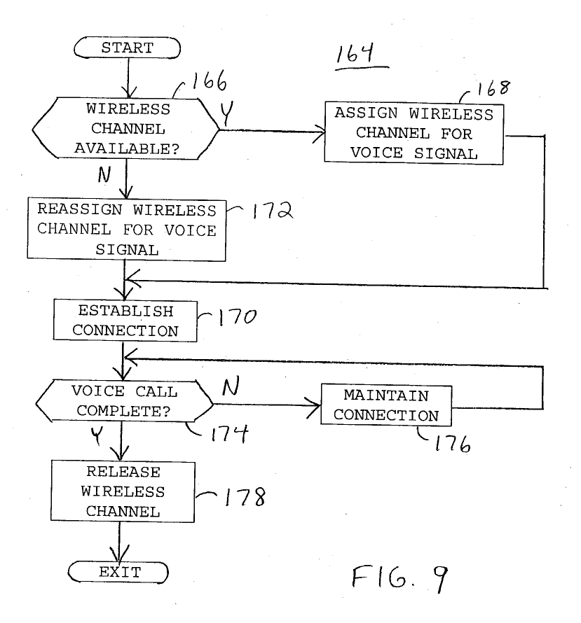

When query task 128 determines that transmit signal 64 exhibits time-critical, low-data-rate data class 122, process 112 proceeds to a task 130. At task 130, a voice signal management subprocess is performed. The voice signal management subprocess is described below in connection with FIG. 9.

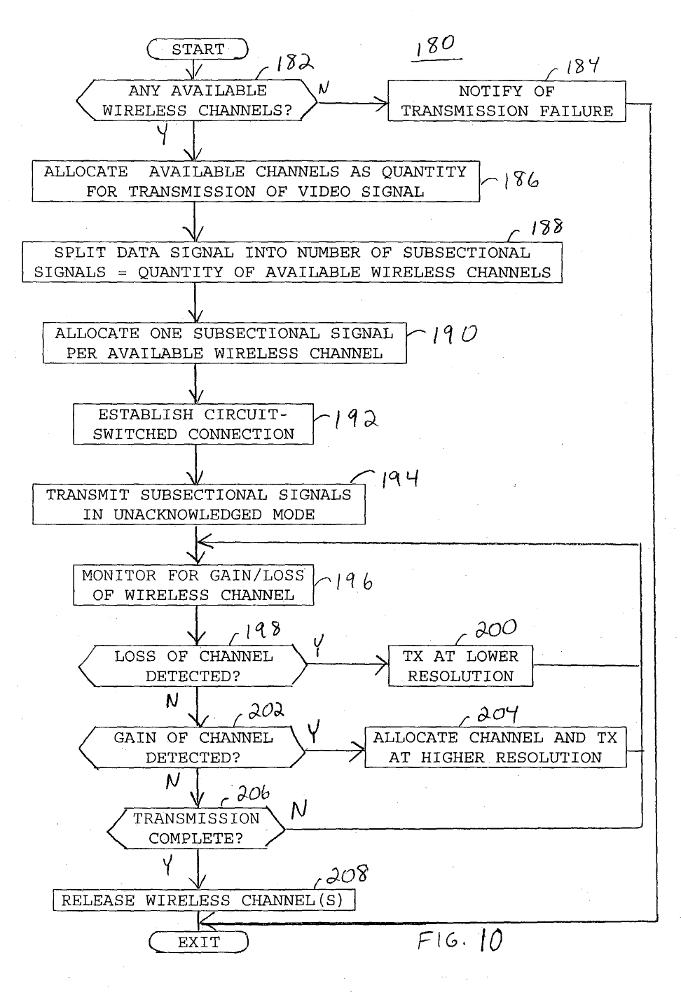

When query task 128 determines that transmit signal 64 exhibits time-critical, high-data-rate data class 124, process 112 proceeds to a task 132. At task 132, a video signal management subprocess is performed. The video signal management subprocess is described below in connection with FIG. 10.

Following the execution of any of tasks 126, 130, and 132, process 112 proceeds to a query task 134. Query task 134 determines whether the execution of channel assignment process 112 is to continue. When the execution of process 112 is to continue, program control loops back to task 114 to continue monitoring for transmit signals 64 to be transmitted. When the execution of process 112 is to be discontinued, process 112 exits. Through the continuous execution of process 112, first IMUX system 50A (FIG. 3) is enabled to determine data types of transmit signals 64, assign wireless traffic channels 46 for transmission of transmit signals, and enable the transmission of transmit signals 64 from first communication station 52 (FIG. 2).

FIG. 8 shows a flow chart of a data signal management subprocess 136 of channel assignment process 112 (FIG. 7). When the detected transmit signal 64 (FIG. 2) exhibits time-noncritical data class 120 (FIG. 7) at query task 116 (FIG. 7) of process 112 (FIG. 7), task 126 (FIG. 7) initiates the execution of data signal management subprocess 136. By way of example, transmit signal 64 is a large data file, i.e., data signal 72. Subprocess 136 begins with a query task 138.

At query task 138, processor 68 ascertains an available number of wireless voice channels 46 associated with L-band transceivers 92 (FIG. 3) of first IMUX system 50A. The available ones of wireless channels 46 are those channels that are not currently not being utilized for the transmission of other signals, for example, for voice signals 86 (FIG. 3) or video signal 73 (FIG. 3).

When query task 138 determines that there are no wireless channels 46 available for the transmission of data signal 72, subprocess 136 proceeds to a task 140. Task 140 provides notification of a transmission failure. Notification may be in the form of a text message at first user/net terminal 56 (FIG. 3), lighting or sound indication on first IMUX system 50A, and so forth. Following task 140, subprocess 136 exits. Those skilled in the art will recognize that subprocess 136 may include additional activities in which data signal 72 is stored at first IMUX system 50A, query task 138 is periodically repeated to ascertain the availability of wireless channels 46, and data signal 72 is eventually transmitted when one or more of wireless channels 46 becomes available.

Returning to query task 138, when task 138 determines that there is at least one available wireless channel 46, subprocess 136 proceeds to a task 142. At task 142, processor 68 allocates the available number of wireless channels 46 to be a quantity of wireless channels 46 for transmission of data signal 72. By way of example, processor 68 may determine that all four of wireless channels 46 are available. As such, task 138 would allocate the four wireless channels 46 for transmission of data signal 72.

Following task 142, data signal management process 136 proceeds to a query task 144. At query task 144, processor 68 determines whether the quantity of wireless channels 46 allocated for transmission of data signal 72 at task 142 is greater than one. When only one of wireless channels 46 is allocated for transmission of data signal 72, program flow proceeds to a task 146 (discussed below). However, when the quantity of channels is greater than one, program flow proceeds to a task 148.

At task 148, IMUX 74 (FIG. 3) splits data signal 72 into a number of subsectional signals equivalent to the quantity of available wireless channels 46. IMUX 74 may utilize time-division multiplexing or other such techniques known to those skilled in the art to split data signal 72 into multiple subsectional signals. In this scenario, processor 68 directs IMUX to generate four subsectional signals 72A, 72B, 72C, and 72D. Those skilled in the art will recognize that an optional lossless compression technique may be applied at first IMUX system 50A prior to inverse multiplexing data signal 72 into subsectional signals 72A, 72B, 72C, and 72D, with decompression being applied at second IMUX system 50B to further increase the effective bandwidth of the circuit-switched connection. Alternatively, for some data types, such as digital imagery, a lossy compression scheme may be applied to provide greater increases in the effective bandwidth of the circuit-switched connection.

A task 150 performed in connection with task 148 allocates one subsectional signal 72A, 72B, 72C, and 72D per available one of wireless channels 46 via IMUX outputs 78 (FIG. 3) and switches 82 (FIG. 3).

Following task 150, and as mentioned above, following a negative response to query task 144, task 146 is performed. At task 146, a circuit-switched connection is established between first communication station 52 and second communication station 54 in accordance with conventional switching procedures of satellite-based communication network 20 (FIG. 1).

Once the circuit-switched connection is established between first and second communication stations 52 and 54, respectively, a task 152 is performed to transmit-signals toward second communication station 54. When only one of wireless channels 46 is utilized for the transmission of data signal 72, task 152 transmits data signal 72 over the single one of wireless channels 46. However, when more than one of wireless channels 46 is allocated for the transmission of data signal 72, task 152 transmits subsectional signals 72A, 72B, 72C, and 72D over the multiple wireless channels 46.

Task 152 causes the transmission of data signal 72, or alternatively, subsectional signals 72A, 72B, 72C, and 72D in an acknowledged mode. The transmission of data signal 72 calls for a reliable mechanism to guarantee that data signal 72 is not altered during transmission. Per convention, for data signal 72 transmission over a single one of wireless channels 46, network 20 provides full-duplex connectivity with a choice of acknowledged and unacknowledged transmission modes. The acknowledged mode provided as a service through the Iridium® commercial system allows for retransmission on a single-packet basis if the packet has been lost or deemed unrecoverable. In a preferred embodiment, this acknowledged mode is utilized when subsectional signals 72A, 72B, 72C, and 72D of data signal 72 are being transmitted over multiple wireless channels 64 to guarantee that the packets being transmitted over the multiple wireless channels 46 can be recovered and appropriately ordered at the receiving IMUX system 50, i.e., second IMUX system 50B. The acknowledged mode provides an overall reliable packet retransmission scheme that supports an arbitrary number of wireless channels.

A task 154 is an ongoing activity performed in connection with task 152 while data signal 72, or alternatively, subsectional signals 72A, 72B, 72C, and 72D, is being transmitted from first IMUX system 50A. At task 154, processor 68 monitors all wireless channels 46 associated with first IUMX system 50A for a gain or loss of any of wireless channels 46. A gain of one of wireless channels 46 could occur if, for example, a voice signal 86 terminates on one of wireless channels 46 that was previously unavailable. Conversely, one of wireless channels 46 currently being used to transmit one of subsectional signals 72A, 72B, 72C, and 72D may become reassigned for transmission of voice signal 86. Alternatively, network 20 can be operated in unacknowledged mode, with the acknowledgment mechanism being implemented by the IMUX processor 68, or any combination of such techniques may be implemented.

A query task 156 performed with task 154 determines whether a gain or loss of one of wireless channels is detected. When a gain or loss is detected, program control loops back to task 142, wherein wireless channels 46 are dynamically reallocated, and data signal 72 is inverse multiplexed at task 148 to a number of subsectional signals equivalent to the remaining quantity of currently available wireless channels 46. When one of wireless channels 46 over which one of subsectional signals 72A, 72B, 72C, and 72D is lost, task 156 causes first IMUX system 50A to automatically reestablish the connection as soon as possible.

When query task 156 determines that there is no change in the number of available wireless channels 46, a query task 158 determines whether transmission of data signal 72 is complete. When transmission of data signal 72 is incomplete, subprocess 136 proceeds to a task 160 where the circuit-switched connection is maintained. Data signal management subprocess 136 then loops back to task 152 to continue the transmission of data signal 72 while monitoring for a change in the number of available wireless channels 46.

However, when query task 158 determines that transmission of data signal 72 is complete, subprocess 136 proceeds to a task 162 wherein wireless channels 46 (FIG. 2) utilized for the transmission of data signal 72, or alternatively, subsectional signals 72A, 72B, 72C, and 72D are released per conventional circuit switching channel release mechanisms.

Following task 162, data signal management subprocess 136 exits. Accordingly, subprocess 136 provides a technique for utilizing multiple wireless channels 46 to effectively increase the bandwidth of network 20 in order to efficiently transmit data signal 72 exhibiting time-noncritical data class 120. (FIG. 7). Moreover, as wireless channels 46 become available or unavailable, first IMUX system 50A can be dynamically switched to facilitate the transmission of data signal 72 in response to the changed number of wireless channels 46.

FIG. 9 shows a flow chart of a voice signal management subprocess 164 of channel assignment process 112 (FIG. 7). When the detected transmit channel 64 (FIG. 2) exhibits time-critical, low-data-rate data class 120 (FIG. 7) at query task 128 (FIG. 7) of process 112, task 130 (FIG. 7) initiates the execution of voice signal management subprocess 164. By way of example, transmit signal 64 is an initiation of a voice conversation, i.e., voice signal 86, detected at one of voice ports 84 (FIG. 3). Subprocess 164 begins with a query task 166.

At query task 166, processor 68 determines the availability of the one of wireless voice channels 46 associated, via a corresponding switch 82 (FIG. 3), with the one of voice ports 84 at which voice signal 86 is detected. When wireless voice channel 46 is available, program control proceeds to a task 168. At task 168, wireless channel 46 is assigned for the transmission of voice signal 86. A task 170, discussed below, is performed following task 168.

However, when query task 166 determines that the one of wireless voice channels 46 is unavailable, program control proceeds to a task 172. In a preferred embodiment, the transmission of voice signals 86 are prioritized over the transmission of data signal 72. In an optional scenario, the transmission of voice signals 86 may also be prioritized over the transmission of video signal 73 (FIG. 3). Accordingly, task 172 causes processor 68 to reassign the wireless channel 46 for transmission of voice signal 86. In the case of wireless channel 46 being used to transmit subsectional signals of data signal 72, the loss of wireless channel 46 is detected at query task 156 (FIG. 8) of data signal management subprocess 136 (FIG. 8), and subsequent activities are performed as previously discussed.

In response to task 172, and as mentioned above, following task 168, task 170 establishes a circuit-switched connection between first communication station 52 and either second communication station 54 or any telephone throughout the globe, in accordance with conventional switching procedures of satellite-based communication network 20 (FIG. 1).

A query task 174 performed in response to task 172 monitors the circuit-switched connection to determine whether the voice call is complete. When the voice call is incomplete at query task 174, a task 176 maintains the circuit-switched connection, and subprocess 164 loops back to query task 174 to continue to monitor for the completion of the voice call. However, when query task 174 determines that the voice call is complete, subprocess 164 proceeds to a task 178 wherein the wireless channel 46 utilized for the transmission of voice signal 86 is released per conventional circuit switching channel release mechanisms. Following task 178, voice signal management subprocess 164 exits. Accordingly, subprocess 164 provides a technique for prioritizing and enabling two-way voice communication for which satellite-based communication network 20 is currently optimized.

FIG. 10 shows a flow chart of a video signal management subprocess 180 of channel assignment process 112 (FIG. 7). When the detected transmit signal 64 (FIG. 2) exhibits time-critical, high data rate data class 124 (FIG. 7) at query task 128 (FIG. 7) of process 112, task 132 (FIG. 7) initiates the execution of video signal management subprocess 180. By way of example, transmit signal 64 is a video conferencing signal, i.e., video signal 73. As such, subprocess 180 begins with a query task 182.

At query task 182, processor 68 ascertains an available number of wireless voice channels 46 associated with L-band transceivers 92 (FIG. 3) of first IMUX system 50A. As discussed previously, within the Iridium® commercial system, traffic channels 46 are capable of approximately 2.4 kbps raw data throughput. A single one of the 2.4 kbps traffic channels may be insufficient for real-time transmission of video. As such, query task 182 may also determine whether there is a sufficient quantity of available wireless channels 46 to accommodate the transmission of video signal 73. The available ones of wireless channels 46 are those channels that are not currently being utilized for the transmission of other signals, for example, for voice signals 86 (FIG. 3).

When query task 182 determines that there are no wireless channels 46 available or an insufficient quantity of wireless channels available for the transmission of video signal 73, subprocess 180 proceeds to a task 184.

Task 184 provides notification of a transmission failure. Notification may be in the form of a text message at first user/net terminal 56 (FIG. 3), lighting or sound indication on first IMUX system 50A, and so forth. Following task 184, subprocess 180 exits. Those skilled in the art will recognize that subprocess 180 may include additional activities in which the transmission of video signal 73 is prioritized over the transmission of data signal 72. As such, the transmission of data signal 72 may be optionally discontinued, or allocated to a single one of wireless channels 46 to accommodate the transmission of video signal 73.

Returning to query task 182, when query task 182 determines that there is a sufficient number of available wireless channels 46, subprocess 180 proceeds to a task 186. At task 186, processor 68 allocates the available number of wireless channels 46 to be a quantity of wireless channels 46 for transmission of video signal 73. By way of example, processor 68 may determine that all four of wireless channels 46 are available. As such, task 138 would allocate the four wireless traffic channels 46 for transmission of video signal 73.

Following task 186, a task 188 is executed. At task 188, IMUX 74 (FIG. 3) splits video signal 73 into a number of subsectional signals equivalent to the quantity of available wireless channels 46. IMUX 74 may utilize time-division multiplexing or other such techniques known to those skilled in the art to split the video signal 73 into multiple subsectional signals. In this scenario, processor 68 directs IMUX to generate four subsectional signals 73A, 73B, 73C, and 73D. Those skilled in the art will recognize that an optional lossless or lossy compression technique may be applied to video signal 73 at first IMUX system 50A, prior to inverse multiplexing video signal 73 into subsectional signals 73A, 73B, 73C, and 73D, with decompression being applied at second IMUX system 50B, to further increase the effective bandwidth of the circuit-switched connection. Lossy compression may be applied to video signal 73 to provide greater compression ratios. Some drop in the quality of video signal 73 may occur because some of the data in the image is lost when applying lossy compression. However, this decrease in the quality of video signal 73 is not likely to be detrimental.

A task 190, performed in connection with task 186, allocates one subsectional signal 73A, 73B, 73C, and 73D per available one of wireless channels 46 via IMUX outputs 78 (FIG. 3) and switches 82 (FIG. 3).

Following task 190, a task 192 establishes a circuit-switched connection between first communication station 52 and second communication station 54 in accordance with conventional switching procedures of satellite-based communication network 20 (FIG. 1).

Once the circuit-switched connection is established between first and second communication stations 52 and 54, respectively, at task 192, a task 194 is executed. At task 194, subsectional signals 73A, 73B, 73C, and 73D are transmitted over wireless channels 46 toward second communication station 54.

In a preferred embodiment, task 194 causes the transmission of subsectional signals 73A, 73B, 73C, and 73D in an unacknowledged mode. The transmission of time-critical video signal 73 calls for a mechanism to minimize unacceptable delays during transmission. The unacknowledged mode provided as a service through the Iridium® commercial system, exemplified by network 20, does not allow packet retransmission so as to prevent the unacceptable delays associated with packet retransmission. In an unacknowledged transmission mode, packets on any of wireless channels 46 may be lost. However, some packet loss may be acceptable in exchange for less delay in the transmission of video signal 73. Losses may be compensated by compression/decompression techniques known to those skilled in the video coding art that incorporate error correction encoding/decoding.

A task 196 is performed in connection with transmission task 194. At task 196, processor 68 monitors all wireless channels 46 associated with first IUMX system 50A for a gain or loss of any of wireless channels 46. A gain of one of wireless channels 46 could occur if, for example, a voice signal 86 terminates on one of wireless channels 46 that was previously unavailable. In addition, one or more wireless channels 46 may become nonfunctional at any time, since calls are dropped from time-to-time within satellite-based communication network 20 (FIG. 1) or a voice signal with higher priority may appear to claim the channel.

A query task 198 is performed in combination with task 196. Query task 198 determines whether a loss of one of wireless channels 46 currently transmitting one of subsectional signals 73A, 73B, 73C, and 74D is detected. When a loss of one of wireless channels 46 is detected, subprocess 180 continues with a task 200. At task 200, transmission of the remaining subsectional signals 73A, 73B, 73C, and 74D over the remaining wireless channels is continued. Thus, for the period of time of wireless channel 46 loss, video signal 73 is transmitted at a lower resolution. Subproccess 180 loops back to task 196 to continue monitoring for a gain or loss of any of wireless channels 46. Those skilled in the video coding art will appreciate that lossy compression techniques may be adjusted to achieve greater compression in support of the lower-resolution mode of transmission.

When query task 198 determines that there is no loss of one of wireless channels 46, subprocess 180 continues with query task 202 to determine whether the lost one of wireless channels 46 is recovered, i.e., gained. Accordingly, when one of wireless channels 46 over which one of subsectional signals 73A, 73B, 73C, and 73D is lost, task 202 causes first IMUX system 50A to automatically reestablish the connection as soon as possible.

When the lost one of wireless channels 46 is detected at task 202, a task 204 reallocates the lost one of wireless channels for transmission of the dropped one of subsectional signals 73A, 73B, 73C, and 74D. Thus, once the wireless channel 46 is reconnected, video signal 73 is transmitted at a higher resolution. Subproccess 180 loops back to task 196 to continue monitoring for a gain or loss of any of wireless channels 46.

When query task 202 fails to detect the gain of the lost one of wireless channels 46, program control proceeds to a query task 206. Query task 206 determines whether transmission of video signal 73 is complete. By way of example, query task 206 may monitor for signaling indicating the termination of a teleconferencing session. When transmission of video signal 73 is not complete, subprocess 180 loops back to task 196 to continue monitoring for a gain or loss of any of wireless channels 46.

However, when query task 206 determines that transmission is complete, program control proceeds to a task 208 wherein wireless channels 46 (FIG. 2) utilized for the transmission of subsectional signals 73A, 73B, 73C, and 73D of video signal 73 are released per conventional circuit switching channel release mechanisms.

Following task 208, video signal management subprocess 180 exits. Accordingly, subprocess 180 provides a technique for utilizing multiple wireless channels 46 to effectively increase the bandwidth of network 20 in order to transmit video signal 73 exhibiting time-critical, high-data-rate data class 124. (FIG. 7). Moreover, as wireless channels 46 become available or unavailable, first IMUX system 50A can dynamically be switched to facilitate the transmission of the highest possible resolution of video signal 73.

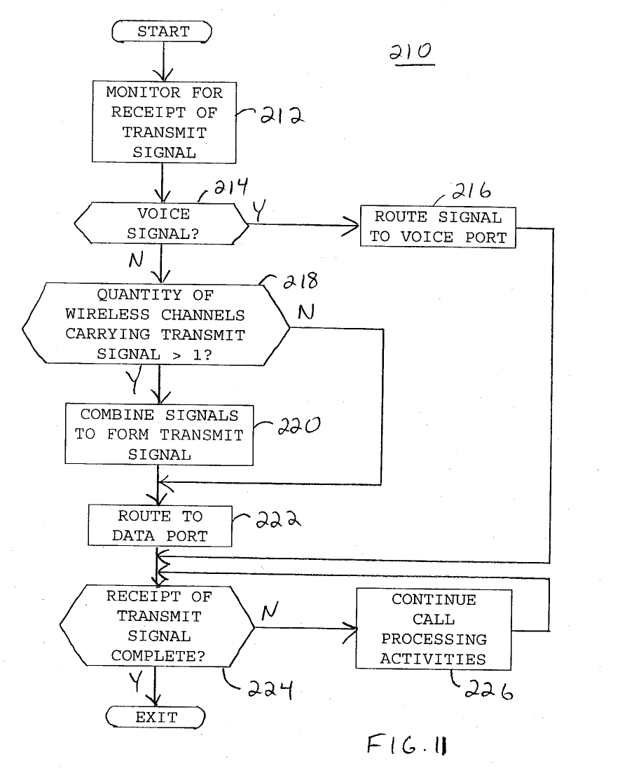

FIG. 11 shows a flow chart of a transmit signal receipt process 210 of the present invention. As discussed in connection with FIGS. 8-10, wireless channels 46 are allocated and circuit-switched connections are established between a transmitting station, i.e., first communication station 52, and a receiving station, i.e. third communication station 64, for the transmission of transmit signal 64. Transmit signal receipt process 210 is performed to monitor for the receipt of transmit signal 64 and to appropriately process the received transmit signal 64.

Process 210 begins with a task 212. At task 212, second IMUX system 50B (FIG. 2) monitors for the receipt of transmit signal 64. In other words, second IMUX system 50B monitors for acquisition signaling indicating that first IMUX system 50A desires wireless communication with second IMUX system 50B. Second IMUX system 50B may thus respond with an acknowledgement that second IMUX system 50B is available to receive wireless communication originated elsewhere.

When transmit signal 64 is received, process 210 proceeds to a task 214. At task 214, processor 68 determines whether transmit signal 64 is voice signal 86. When transmit signal 64 is voice signal 86, a task 216 is performed to actuate the appropriate switching at switches 82 to route voice signal 86 to the corresponding one of voice ports 84 (FIG. 3).

However, when transmit signal 64 is not a voice signal 86, process 210 proceeds with a query task 218. At query task 218, processor 68 determines whether the quantity of wireless channels 46 conveying transmit signal 64 is greater than one.

When the quantity of wireless channels 46 is greater than one, a task 220 is performed. At task 220, IMUX 74 performs inverse demultiplexing activities to combine the received subsectional signals of transmit signal 64 to form the original data or video signal 72 or 73, respectively. The subsectional signals all arrive at the same destination, i.e., second IMUX system 50B, but not necessarily at the same time or in the right order. Accordingly, IMUX 74 may buffer the arriving packets and puts them in the proper order, in accordance with known methodology.

Following inverse demultiplexing activities at task 220, a task 222 causes data or video signal 72 or 73 to be routed to data port 70 (FIG. 3). Similarly, when task 218 determines that the quantity of wireless channels 46 is only one, program control proceeds to task 222 where the intact data or video signal 72 or 73 is routed to data port 70 (FIG. 3).

Following task 222, a query task 224 determines whether the receipt of transmit signal 64 is complete. Similarly, following task 216, at which voice signal 86 is routed to voice port 84 (FIG. 3), query task 224 is performed to determine whether the receipt of transmit signal 64 is complete. For example, second IMUX system 50B may monitor for signaling indicating the termination of wireless communication of transmit signal 64.

When transmission is incomplete, a task 226 is performed to continue call processing activities associated with the particular received transmit signal 64, i.e., voice signal 86, data signal 72, or video signal 73. Alternatively, when query task 224 determines that transmission is complete, process 210 exits. As such, through the execution of process 210, voice signals 86 allocated to single wireless channels 48 are routed directly to voice ports 84. In addition, transmit signals that were inverse multiplexed at the transmitting communication station are inverse demultiplexed at the receiving communication station.

In summary, the present invention teaches of a system and method for utilizing wireless channels in a satellite-based communication network. The system and method facilitate the transmission of large data files and real-time video imagery over low-data-rate wireless channels optimized for voice communication by inverse multiplexing an input transmit signal, and transmitting different portions of the data or video signal over separate wireless traffic channels. The net result of such a system and method is that the effective bandwidth multiplication is directly proportional to the number of traffic channels used for transmission. Accordingly, the system and method facilitates bandwidth-expandable communications capability for the transmission of voice, video, and data without the need for additional terrestrial or airborne infrastructure to the existing infrastructure of the satellite-based communication network.

Although the preferred embodiments of the invention have been illustrated and described in detail, it will be readily apparent to those skilled in the art that various modifications may be made therein without departing from the spirit of the invention or from the scope of the appended claims. For example, a great variation in the order of tasks may be contemplated. Furthermore, transmit signals exhibiting different data types than those specified may be transmitted via the present invention. In addition, other signal prioritization schemes may be employed for determining the assignment and allocation of the wireless channels to particular transmit signals.

What is claimed is:

1. A method for utilizing wireless channels in a wireless communication system, said wireless communication system including a first communication station and a second communication station, and said method comprising:
detecting a transmit signal at said first communication station;
determining a data type of said transmit signal;
assigning a quantity of said wireless channels for transmission of said transmit signal in response to said data type; and
enabling transmission of said transmit signal toward said second communication station over said quantity of said wireless channels.

2. A method as claimed in claim 1 wherein said enabling operation comprises establishing a circuit-switched connection using said quantity of said wireless channels between said first and second communication stations.

3. A method as claimed in claim 1 wherein said wireless communication system is a satellite-based communication network that includes earth-orbiting satellites, and said method further comprises transmitting said transmit signal over said quantity of said wireless channels between said first communication station and one of said earth-orbiting satellites.

4. A method as claimed in claim 1 wherein said wireless communication system is a satellite-based communication network and said wireless channels are wireless voice channels managed by said satellite-based communication network.

5. A method as claimed in claim 1 wherein:
said determining operation comprises identifying said data type as being a time-critical class having a data rate corresponding to a predetermined data rate of one of said wireless channels; and
said assigning operation assigns said quantity as being one of said wireless channels.

6. A method as claimed in claim 5 wherein said transmit signal is a voice signal.

7. A method as claimed in claim 1 wherein:
said determining operation comprises identifying said data type as being a time-noncritical class; and
said assigning operation comprises:
ascertaining an available number of said wireless channels; and
allocating said available number of said channels to be said quantity of said wireless channels, said quantity of said wireless channels being greater than one.

8. A method as claimed in claim 7 further comprising transmitting said transmit signal in an acknowledged mode.

9. A method as claimed in claim 8 wherein said wireless communication system is an earth-orbiting satellite-based communication network, and said acknowledged mode is a communication service provided by said network.

10. A method as claimed in claim 1 wherein:
said determining operation comprises identifying said data type as being a time-critical class having a data rate that exceeds a predetermined data rate of each of said wireless channels; and
said assigning operation comprises:
ascertaining an available number of said wireless channels; and
allocating said available number of said channels to be said quantity of said wireless channels, said quantity of channels being greater than one.

11. A method as claimed in claim 10 wherein said transmit signal is a video signal.

12. A method as claimed in claim 10 further comprising transmitting said transmit signal in an unacknowledged mode.

13. A method as claimed in claim 12 wherein said wireless communication system is an earth-orbiting satellite-based communication network, and said unacknowledged mode is a communication service provided by said network.

14. A method as claimed in claim 1 wherein when said quantity of said wireless channels is more than one, said enabling operation comprises:
splitting said transmit signal into a number of subsectional signals, said number corresponding to said quantity of said wireless channels;
allocating one each of said number of said subsectional signals for transmission over one each of said quantity of said wireless channels; and
transmitting said number of said subsectional signals over said quantity of said wireless channels.

15. A method as claimed in claim 14 further comprising:
receiving said subsectional signals at said second communication station; and
combining said subsectional signals to form said transmit signal.

16. A method as claimed in claim 14 wherein said transmit signal is a first transmit signal, and said method further comprises:
detecting a second transmit signal at said first communication station;
determining said data type of said second transmit signal as being a time critical class having a data rate corresponding to a predetermined data rate of one of said wireless channels; and
reassigning one of said quantity of said wireless channels for transmission of said second transmit signal.

17. A method as claimed in claim 16 further comprising reallocating remaining ones of said quantity of said wireless channels for transmission of said first transmit signal.

18. A method as claimed in claim 17 wherein said reallocating operation comprises:
splitting said first transmit signal into a second number of said subsectional signals, said second number corresponding to said remaining ones of said quantity of said wireless channels;
allocating one each of said second number of said subsectional signals for transmission over said remaining ones of said quantity of said wireless channels; and
transmitting said second number of said subsectional signals over said remaining ones of said quantity of said wireless channels to said second communication station.

19. In a wireless communication system, an apparatus for selectively utilizing wireless channels, said apparatus comprising:
a data input/output (I/O) port for receiving a data signal;
an inverse multiplexer in communication with said data I/O port;
a voice port for receiving a voice signal;
transceivers in selective communication with each of said voice port and an output of said inverse multiplexer, one each of said transceivers supporting one each of said wireless channels; and
a processor in communication with said inverse multiplexer, said voice port, and said transceivers for enabling transmission of said data signal and said voice signal via said transceivers over said wireless channels, said processor performing operations including:
when said data signal is received, determining a data type for said data signal, ascertaining an available number of said wireless channels, and allocating said available number of said channels to be a quantity of said wireless channels for transmission of said data signal, said quantity of said wireless channels being greater than one; and
when said voice signal is received, assigning one of said wireless channels for transmission of said voice signal.

20. An apparatus as claimed in claim 19 wherein said transceivers supporting said quantity of said wireless channels establish a circuit-switched connection for transmission of said data signal.

21. An apparatus as claimed in claim 19 wherein said transceiver supporting said one of said wireless channels establishes a circuit-switched connection for transmission of said voice signal.

22. An apparatus as claimed in claim 19 wherein said wireless communication system is a satellite-based communication network that includes earth-orbiting satellites, and said transceivers transmit said data signal and said voice signal to ones of said earth-orbiting satellites.

23. An apparatus as claimed in claim 19 wherein said wireless communication system is a satellite-based communication network and said wireless channels are wireless voice channels managed by said satellite-based communication network.

24. An apparatus as claimed in claim 19 wherein when said data type of said data signal is a time-noncritical class, said processor enables transmission of said data signal in an acknowledged mode.

25. An apparatus as claimed in claim 24 wherein said wireless communication system is an earth-orbiting satellite-based communication network, and said acknowledged mode is a communication service provided by said network.

26. An apparatus as claimed in claim 19 wherein when said data type of said data signal is a time-critical class, said processor enables transmission of said data signal in an unacknowledged mode.

27. An apparatus as claimed in claim 26 wherein said wireless communication system is an earth-orbiting satellite-based communication network, and said unacknowledged mode is a communication service provided by said network.

28. An apparatus as claimed in claim 19 wherein:
when said quantity of said wireless channels is more than one, said inverse multiplexer splits said data signal into a number of subsectional signals, said number corresponding to said quantity of said wireless channels;
said processor allocates one each of said number of said subsectional signals for transmission over one each of said quantity of said wireless channels via corresponding ones of said transceivers; and
said transceivers transmit said number of said subsectional signals over said quantity of said wireless channels.

29. An apparatus as claimed in claim 19 wherein when said voice signal is detected, said processor reassigns one of said quantity of said wireless channels for transmission of said voice signal.

30. An apparatus as claimed in claim 29 wherein said processor reallocates remaining ones of said quantity of said wireless channels for transmission of said data signal.

31. In a satellite-based communication network that includes earth-orbiting satellites, a method for utilizing wireless channels of said network to communicate between a first communication station and a second communication station comprising:
detecting a transmit signal at said first communication station;
determining, at said first communication station, a data type of said transmit signal;
assigning, at said first communication station, a quantity of said wireless channels for transmission of said transmit signal in response to said data type;
transmitting said transmit signal over said quantity of said wireless channels between said first communication station and one of said earth-orbiting satellites;
forwarding said transmit signal from said one of said earth-orbiting satellites toward said second communication station; and
receiving, at said second communication station, said transmit signal from said first communication station.

32. A method as claimed in claim 31 further comprising establishing a circuit-switched connection for said transmit signal between said first and second communication stations, said circuit-switched connection utilizing said quantity of said wireless channels between said first communication station and said one earth-orbiting satellite and said quantity of said wireless channels between said one earth-orbiting satellite and said second communication station.

33. A method as claimed in claim 31 wherein said satellite-based communication network includes a gateway for directing communication between said earth-orbiting satellites and a public switched telephone network (PSTN), said second communication station is in communication with said gateway via said PSTN, and said forwarding operation forwards said transmit signal for receipt at said gateway.

34. A method as claimed in claim 31 wherein said wireless channels are voice channels.

35. A method as claimed in claim 31 wherein:
when said quantity of said wireless channels is more than one, said first communication station performs further operations comprising:
splitting said transmit signal into a number of subsectional signals, said number corresponding to said quantity of said wireless channels; and
allocating one each of said number of said subsectional signals for transmission over one each of said quantity of said wireless channels; and
said receiving operation performed at said second communication station comprises:
receiving said subsectional signals over said quantity of said wireless channels; and
combining said subsectional signals to form said transmit signal.

36. A method as claimed in claim 31 wherein:
when said quantity of said wireless channels is more than one, said first communication station performs further operations comprising:
splitting said transmit signal into a number of subsectional signals, said number corresponding to said quantity of said wireless channels; and
allocating one each of said number of said subsectional signals for transmission over one each of said quantity of said wireless channels; and
said receiving operation performed at said second communication station comprises:
receiving said subsectional signals over a number of PSTN links, said number of PSTN links corresponding to said quantity of said wireless channels; and
combining said subsectional signals to form said transmit signal.

37. A method as claimed in claim 31 wherein:
said determining operation identifies said transmit signal as a voice signal whose said data type is a time-critical class; and
said assigning operation assigns said quantity as being one of said wireless channels.

38. A method as claimed in claim 31 wherein:
said determining operation identifies said transmit signal as a data signal whose said data type is a time-noncritical class; and
said assigning operation comprises:
ascertaining an available number of said wireless channels; and
allocating said available number of said channels to be said quantity of said wireless channels, said quantity of said wireless channels being greater than one.

39. A method as claimed in claim 38 wherein said data signal is transmitted in an acknowledged mode, said acknowledged mode being a communication service provided by said satellite-based communication network.

40. A method as claimed in claim 31 wherein:
said determining operation identifies said transmit signal as a video signal whose said data type is a time-critical class having a data rate that exceeds a predetermined data rate of each of said wireless channels;
said assigning operation comprises:
ascertaining an available number of said wireless channels; and
allocating said available number of said channels to be said quantity of said wireless channels, said quantity of channels being greater than one.

41. A method as claimed in claim 40 wherein said video signal is transmitted in an unacknowledged mode, said unacknowledged mode being a communication service provided by said satellite-based communication network.

42. A method as claimed in claim 31 wherein said satellite-based communication network includes a gateway for directing communication between said earth-orbiting satellites and a public switched telephone network (PSTN) and said second communication station is incorporated in said gateway.

43. In a satellite-based global communication network that supports communication over wireless voice channels via earth-orbiting satellites, a system for utilizing said wireless voice channels to convey a data signal from a first terminal to a second terminal, said system comprising:
a first communication station including:
a first data input/output (I/O) port for detecting said data signal from said first terminal;
a first inverse multiplexer in communication with said first data I/O port, said inverse multiplexer splitting said data signal into a number of subsectional signals, said number corresponding to a quantity of said wireless voice channels that are available for transmitting said data signal; and
first transceivers in communication with an output of said inverse multiplexer, one each of said first transceivers supporting one each of said wireless voice channels, said first transceivers transmitting said number of said subsectional signals over said quantity of said wireless channels to one of said earth-orbiting satellites; and
a second communication station including:
receiving elements for receiving said subsectional signals forwarded from said one of said earth-orbiting satellites;
a second inverse multiplexer in communication with said receiving elements for reverse inverse multiplexing said subsectional signals to form said data signal; and
a second data I/O port in communication with said second inverse multiplexer for passing said data signal to said second terminal.

44. A system as claimed in claim 43 wherein said first communication station further includes:
a voice port for detecting a voice signal; and
a processor in communication with said voice port, said inverse multiplexer, and said first transceivers, such that when said voice signal is detected, said processor reassigns one of said quantity of said wireless voice channels for transmission of said voice signal, and enables a corresponding one of said first transceivers to transmit said voice signal over said one of said quantity of said wireless voice channels.

45. A system as claimed in claim 44 wherein:
said first inverse multiplexer splits said data signal into a second number of said subsectional signals, said second number corresponding to a remaining quantity of said wireless voice channels that are available for transmitting said data signal; and
remaining ones of said first transceivers supporting said remaining quantity said wireless channels transmit said second number of said subsectional signals over said remaining quantity of said wireless voice channels to said one of said earth-orbiting satellites.

46. A system as claimed in claim 44 wherein said receiving elements are transceivers configured to communicate with said earth-orbiting satellites using said wireless voice channels.

47. A system as claimed in claim 43 wherein said satellite-based communication network includes a gateway for directing communication between said earth-orbiting satellites and a public switched telephone network (PSTN), and said receiving elements of said second communication station are modems configured to communicate with said earth-orbiting satellites via said PSTN and said gateway using individual PSTN links.
